(19) United States
(12) Patent Application Publication
(10) Pub. No.: US 2026/0063108 A1
(43) Pub. Date: Mar. 5, 2026

(54) MODULAR FLOATING STRUCTURE FOUNDATION FOR WIND TURBINE

(71) Applicant: Jun Zou, Houston, TX (US)

(72) Inventor: Jun Zou, Houston, TX (US)

(21) Appl. No.: 18/822,433

(22) Filed: Sep. 2, 2024

(51) Int. Cl. F03D 13/25; B63B 35/44; B63B 75/00

(52) U.S. Cl. CPC F03D 13/256; B63B 75/00; B63B 2035/446; F05B 2230/60

(57) ABSTRACT

A floating structure foundation for a wind turbine features several improvements, including a transition assembly that supports the wind turbine generator (WTG) and tower centrally, transferring loads to primary structural components to maximize efficiency. Its highly modular design allows for flexible construction and scalability, with each component built independently for easier adaptation to different project requirements and site conditions. This modularity supports efficient dry transport, enabling multiple modules to be shipped simultaneously on various vessels. The foundation offers a simplified design with accelerated construction, rapid assembly, and installation.

### BACKGROUND

Floating offshore platforms and structures have been used for various purposes over the years, including the extraction of natural resources like oil and gas and the generation of wind energy. Initially, these structures were rigid and extended directly to the ocean floor. With advancements in technology, their design has evolved to meet the challenges of deeper waters and more demanding marine environments. Today, floating platforms come in different types, such as Spar platforms, Semi-submersible (SEMI) platforms, and Tension Leg Platforms (TLPs), each offering specific advantages tailored to various operational needs.

One use of floating structures is for wind turbines. Floating offshore wind turbine (FOWT) platform features a buoyant foundation that supports a tower, which is topped with a nacelle and blades. The semi-submersible type platform is one of the most popular FOWT concepts. Among semi-submersible FOWTs, they are generally categorized into two groups: one with the RNA (Rotor-Nacelle Assembly)/tower mounted on top of a single column (FIG. 1), and the other with the RNA/tower installed at the center of the platform (FIG. 2 and FIG. 3). In the centered RNA/tower arrangements, there are two ways to support the RNA/tower: one is to locate it on top of the central column (FIG. 2), and the other is to support it by assembling a deck, three major inclined trusses, and six vertical connection trusses (FIG. 3).

Recently, wind turbines have grown substantially in size. For instance, contemporary wind turbines on a floating structure can have a hub height (the vertical distance from the mean waterline to the center of the rotor) of 150 meters (15 MW), with rotor blades extending up to 240 meters in diameter.

As shown in FIG. 1, several shortcomings are highlighted: a) Major weights and loads are concentrated on one column, while the other two columns carry minimal load, making them less effective; b) The RNA's off-center position leads to additional accelerations from platform rotations; c) The concentration of weight on one column requires the other two columns to carry excessive ballast to maintain an even keel, resulting in deeper drafts, potential exclusion from some construction yards, fewer competitors, and higher costs. Alternatives include adding a temporary buoyancy module, which incurs extra costs, or enlarging the supporting column, which increases hull steel weight and construction complexity. Additionally, larger wind turbines, such as those rated at 15 MW, exacerbate these issues, requiring a greater span between columns for structural rigidity and leading to higher hull steel and construction costs. Overall, the off-centered RNA/tower configuration becomes increasingly inefficient for very large turbines, raising the Levelized Cost of Energy (LCOE).

As illustrated in FIG. 2, several weaknesses are highlighted: i) The RNA/tower are situated on the central column, while the other three columns contribute minimally to load sharing. This arrangement makes the outer columns less effective, resulting in higher column weight, costs, and a lower LCOE; ii) The lack of direct connections between the outer columns means that pontoons must bear nearly all the load, increasing their strength and fatigue resistance requirements, and consequently their weight and cost; iii) Compared to the off-centered RNA/tower platform, the addition of one extra column and three larger pontoons significantly increases hull loads and mooring size, leading to a higher LCOE. These disadvantages make the platform and mooring configurations increasingly ineffective, especially for very large turbines rated at 15 MW or higher, where the inefficiencies and higher LCOE become more pronounced.

As shown in FIG. 3, several limitations are summarized as follows: 1) With larger wind turbines, such as 15 MW turbines, the column span must increase significantly. The decreased angle of the inclined trusses due to their connection near the bottom of the columns reduces their effectiveness in supporting larger RNAs and taller towers. This necessitates a substantial increase in the dimensions of the inclined trusses, leading to higher hull steel weight and costs; 2) The column span increase requires reconfiguring the arrangement of the three main columns because the single horizontal truss at the bottom does not provide adequate strength to resist loads between adjacent columns; 3) The six vertically inclined trusses, which form triangular shapes and connect to the horizontal truss frame, will require significant increases in size and weight to maintain rigidity with a larger column span, making the solution less cost-effective. These limitations render the proposed platform configurations increasingly inefficient for very large turbines, such as those rated at 15 MW or higher, raising the LCOE.

One of the biggest roadblocks for FOWT farms is the high cost of wind-generated power compared to conventional energy sources. The price of wind energy remains significantly higher than that of traditional power, creating a substantial economic barrier. To address this challenge, the industry is committed to halving the LCOE within a stringent timeline. Achieving this goal is crucial for reducing costs, making FOWTs more competitive, and accelerating the transition away from conventional energy sources toward more sustainable alternatives.

This invention is designed to achieve a significant reduction in LCOE by implementing a holistic approach that spans the entire lifecycle of developing a FOWT farm. This approach integrates improvements across all stages, including design, construction, transportation, installation, and operations and maintenance (O&M). By addressing each phase comprehensively, the goal is to optimize efficiency, reduce costs, and enhance the overall economic feasibility of FOWT projects.

This invention is a modular, centrally located RNA/tower floating structure foundation featuring a simplified design that improves efficiency in construction, assembly, installation, and operations and maintenance (O&M). This approach is designed to halve the LCOE for establishing a FOWT farm in U.S. waters. Currently, the industry lacks a hull design with unique technical features that minimize hull motions and streamline construction, transportation, installation, O&M, and decommissioning. The technology described here provides a comprehensive solution to these challenges.

### SUMMARY OF THE INVENTION

As depicted in FIG. 4, the components of the present floating structure foundation for wind turbine have been broken into nine parts: 1) Three blades; 2) Rotor and Nacelle; 3) Segmented towers; 4) One modular transition assembly; 5) Three modular components of supporting frame assemblies; 6) Three modular components of the column/pontoon assemblies; 7) Three connection beams; 8) Three connection trusses between vertical trusses of the supporting frame assemblies; and 9) Three connection trusses between columns of the column/pontoon assemblies.

The floating offshore wind turbine (FOWT) platform comprises two main components: the hull (floating structure foundation) and the superstructure. The superstructure includes items 1 through 3, as described earlier, and is generally specified based on the design basis. The hull consists of items 4 through 9 and is configured according to the specific design basis and execution plan to ensure it meets the design requirements. The currently invented hull (floating structure foundation) configuration is illustrated in FIG. 5.

In FIG. 5, the modular transition assembly is detailed, with additional specifics provided in FIGS. 6A and 6B. Positioned at the center of the structure foundation, this modular transition assembly acts as a crucial structural component. It forms a robust base that efficiently transfers loads from the wind turbine generator (WTG) through the tower to the hull, ensuring effective load distribution throughout the entire floating structure foundation.

In FIG. 5, the modular component of the supporting frame assembly is detailed, with additional specifics provided in FIGS. 7A and 7B. This modular component serves multiple functions: it acts as a foundation for the modular transition assembly during the hull assembly and functions as a primary structural member. Its role is crucial in efficiently and effectively transferring and distributing the load from the RNA/tower to the three columns of the modular components of the column/pontoon assemblies, ensuring structural integrity and stability throughout both the assembly process and operational phases.

In FIG. 5, the modular component of the column/pontoon assembly is detailed, with additional specifics provided in FIGS. 8A and 8B. This column/pontoon assembly fulfills several critical functions: it ensures stability during both pre-service and in-service conditions, provides primary buoyancy for the floating structure foundation to keep it afloat, and serves as the foundation for supporting substantial loads. Additionally, it supports the mooring system and dynamic cables, which are essential for maintaining the platform's position and operational integrity.

In FIG. 5, the top of the modular component of the supporting frame assembly is connected to the top of the column/pontoon assembly via a connection beam. The bottom of the supporting frame assembly attaches to the inside of the column near its base, and the top of the supporting frame assembly connects to the inside of the column near its top, forming a strong triangular shape that facilitates effective load transfer. Additionally, three supporting frame assemblies are interconnected by three horizontal trusses located at the midpoints of the vertical trusses, providing overall support and rigidity to the structure.

In FIG. 5, the structural components include one modular transition assembly, three modular supporting frame assemblies, three modular column/pontoon assemblies, three connection beams, three connection trusses between the vertical trusses of the modular supporting frame assemblies, and three connection trusses between the columns of the modular column/pontoon assemblies. All these components can be prefabricated and produced independently in parallel, allowing for efficient and streamlined fabrication. This approach also creates opportunities for outsourcing, which can substantially reduce construction costs and turnaround times.

In FIG. 5, three modular column/pontoon assemblies are identified as the most critical modules among all the components, potentially impacting the critical path of the prefabrication schedule. Therefore, it is crucial to ensure that all possible execution plans remain feasible, including considering outsourcing options, to maintain the project timeline and mitigate any potential delays.

In FIGS. 9A-9E, the schematic procedure for loading nine modular components of the column/pontoon assemblies onto a DTV is illustrated. Each modular component is designed to support a 15 MW WTG. The DTV's deck dimensions are assumed to be 180 meters in length and 40 meters in width, allowing for the loading of a total of nine modular components. Offloading these modules follows the reverse of the loading procedure: 1) Remove the nine connection trusses from the DTV deck and place them on land first; 2) Reconnect a connection truss to the last-loaded modular component on the DTV deck; 3) Remove the modular component with the reconnected truss from the DTV deck and place it at the designated location on land; and 4) Repeat steps 1-3 until all modular components are offloaded from the DTV and placed at their designated locations on land.

FIGS. 10A-10L displays the schematic procedure for assembling the modules into a hull (floating structure foundation), as illustrated in FIG. 5. The procedure involves six steps for assembling the prefabricated modules into a hull. First, integrate three modular components of the column/pontoon assemblies (FIGS. 10A and 10B). Second, install all connection plates (FIGS. 10C and 10D). Third, connect three horizontal trusses to the tops of all columns of the modular components of the column/pontoon assemblies (FIGS. 10E and 10F). Fourth, connect three modular components of the supporting frame assemblies to the column/pontoon assemblies and connect three horizontal trusses at the midpoint of the vertical trusses of the supporting frame assemblies (FIGS. 10G and 10H). Fifth, integrate the modular transition assembly onto the three supporting frame assemblies (FIG. 10I and 10J). Finally, install three horizontal beams to connect the tops of the columns of the modular components of the column/pontoon assemblies, the outward ends of the modular transition assembly, and the tops of the vertical trusses of the supporting frame assemblies (FIG. 10K and 10L), ensuring the hull's rigidity.

FIGS. 11A-11C illustrate the schematic procedure for assembling the superstructure-including the tower, nacelle, and blades-onto the hull (floating structure foundation) presented earlier. The assembly process involves three key steps: First, install the lower segment of the tower onto the top of the column of the modular transition assembly (FIG. 11A). Second, position and secure the upper segment of the tower on top of the lower segment (FIG. 11B). Finally, install the nacelle on top of the tower and connect all three blades to the nacelle (FIG. 11C). Following these steps, the current FOWT platform is fully assembled.

### BRIEF DESCRIPTION OF DRAWINGS

FIG. 1 displays an off-centered RNA/Tower Semi-Submersible (Prior Art).

FIG. 2 illustrates a centered RNA/Tower Semi-Submersible (Prior Art).

FIG. 3 depicts a centered RNA/Tower tri-floater Semi-Submersible (Prior Art).

FIG. 4 shows present invention-a breakout view.

FIG. 5 displays the present invention-a perspective view.

FIG. 6A illustrates the present invention of the modular transition assembly (top view).

FIG. 6B illustrates the present invention of the modular transition assembly (perspective view).

FIG. 7A depicts the present invention of the modular supporting frame assembly (top view).

FIG. 7B depicts he present invention of the modular supporting frame assembly (perspective view).

FIG. 8A shows the present invention of the modular column/pontoon assembly (top view).

FIG. 8B shows the present invention of the modular column/pontoon assembly (perspective view).

FIGS. 9A-9E display the schematic procedure for loading nine modular components of the column/pontoon assemblies onto a DTV.

FIG. 9A depicts the DTV and one modular component of the column/pontoon assembly.

FIG. 9B shows one modular component of the column/pontoon assembly loaded onto the DTV, with the connection truss disconnected and temporarily placed at the designated location on land, while the second modular component of the column/pontoon assembly awaits.

FIG. 9C depicts the ninth modular component of the column/pontoon assembly loaded onto the DTV.

FIG. 9D shows the ninth connection truss disconnected and positioned at the designated location on land.

FIG. 9E depicts all nine modular components of the column/pontoon and connection trusses loaded onto the DTV.

FIGS. 10A-10L illustrate the schematic procedure for assembling all structural components into the hull (floating structure foundation).

FIG. 10A depicts three modular components of the column/pontoon assembly hooked up (top view).

FIG. 10B depicts three modular components of the column/pontoon assembly hooked up (perspective view).

FIG. 10C shows both the connection plates between connection trusses and pontoons installed, as well as the connection plates between pontoons and columns at an elevation flat with the top of the pontoon and the connection plates between pontoons and columns at an elevation flat with the bottom of the pontoon (top view).

FIG. 10D shows both the connection plates between connection trusses and pontoons installed, as well as the connection plates between pontoons and columns at an elevation flat with the top of the pontoon and the connection plates between pontoons and columns at an elevation flat with the bottom of the pontoon (perspective view).

FIG. 10E depicts three horizontal trusses and three columns tied together at the top of the columns (top view).

FIG. 10F depicts three horizontal trusses and three columns tied together at the top of the columns (perspective view).

FIG. 10G shows three slanted connection trusses and three slanted trusses connected to the corresponding columns at the top and bottom, respectively; three horizontal connection trusses connected at the middle of the corresponding vertical trusses (top view).

FIG. 10H shows three slanted connection trusses and three slanted trusses connected to the corresponding columns at the top and bottom, respectively; three horizontal connection trusses connected at the middle of the corresponding vertical trusses (perspective view).

FIG. 10I depicts the modular transition assembly lifted, and three connection beams positioned and welded to the corresponding vertical trusses at the top (top view).

FIG. 10J depicts the modular transition assembly lifted, and three connection beams positioned and welded to the corresponding vertical trusses at the top (perspective view).

FIG. 10K shows three connection beams lifted and welded to the corresponding connection beams, vertical trusses, and columns, completing the hull assembly (top view).

FIG. 10L shows three connection beams lifted and welded to the corresponding connection beams, vertical trusses, and columns, completing the hull assembly (perspective view).

FIGS. 11A-11C depict the schematic procedure for assembling the tower, nacelle, and blades onto the FOWT platform.

FIG. 11A depicts the lower segment of the tower lifted and installed on top of the column of the modular transition assembly.

FIG. 11B shows the upper segment of the tower lifted and mounted on top of the lower segment of the tower.

FIG. 11C depicts the nacelle lifted and installed on top of the upper segment of the tower, and then three blades lifted and connected to the nacelle, assembling the FOWT platform.

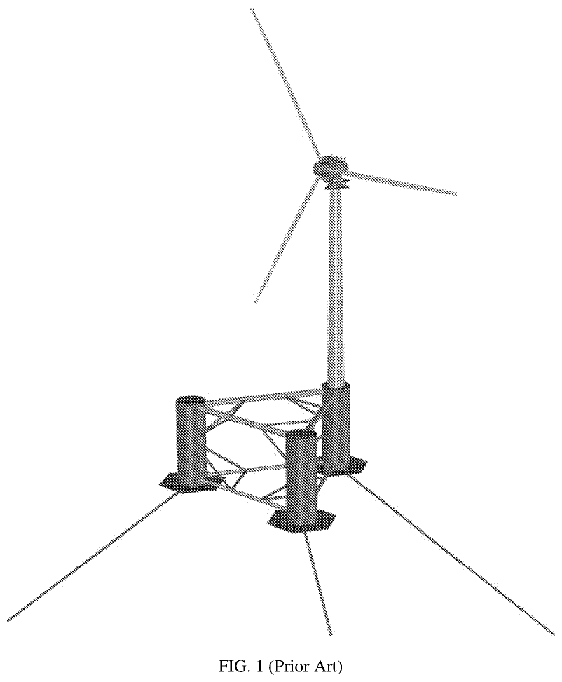

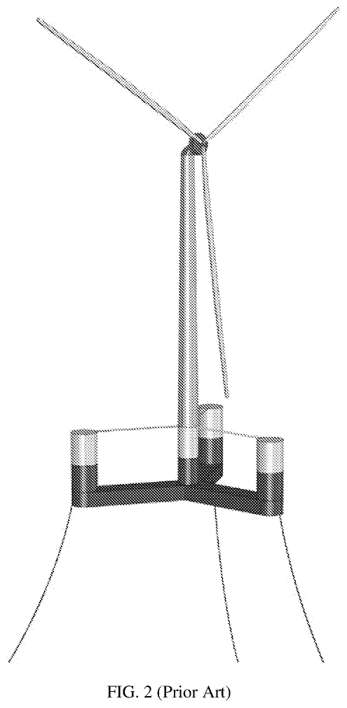

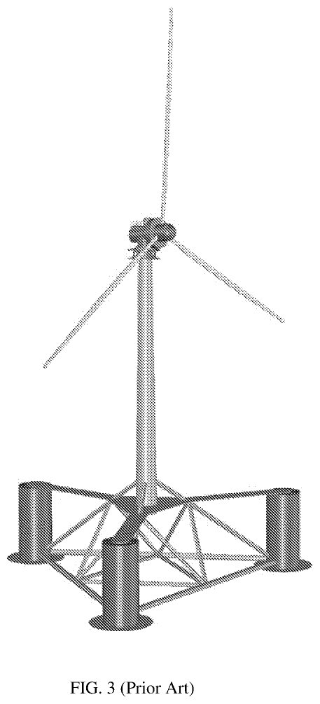

### DETAILED DESCRIPTION

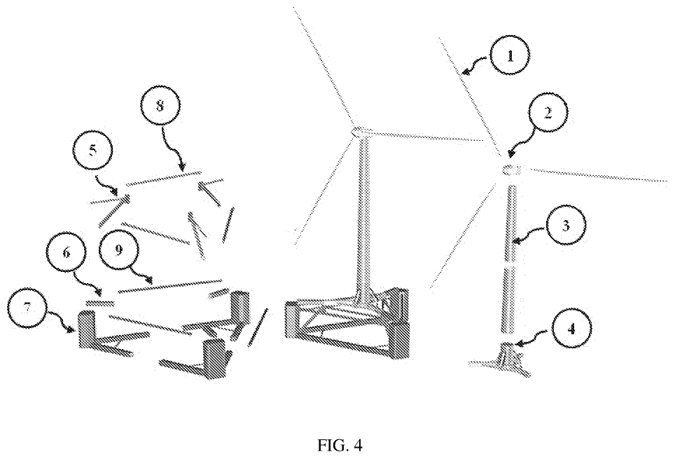

The FOWT platform consists of two main components: the hull (floating structure foundation) and the superstructure. Designed and modularized for a specific WTG and tower, the FOWT platform and its structural components are detailed in FIG. 4. The superstructure, shown as items 1 through 3, is defined according to the design basis. The hull, detailed in FIG. 5, includes items 4 through 9 and is configured to meet the design requirements outlined in the design basis and execution plan.

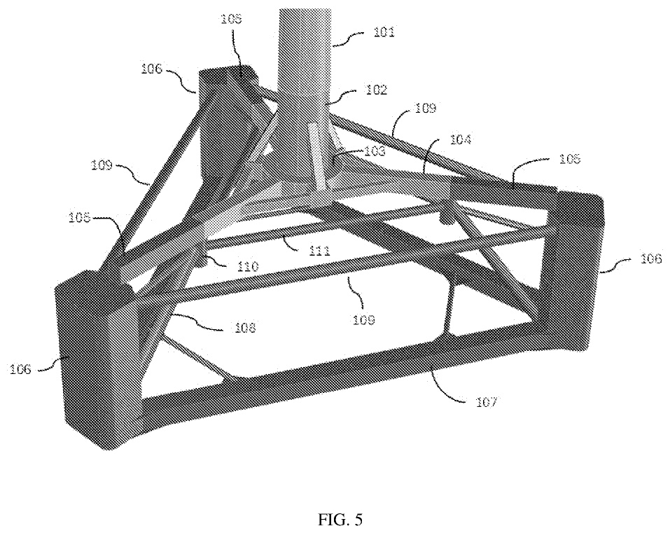

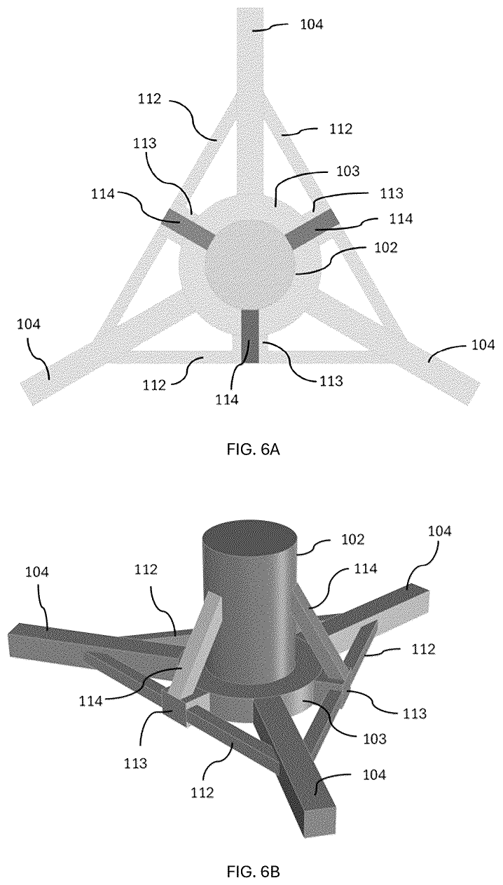

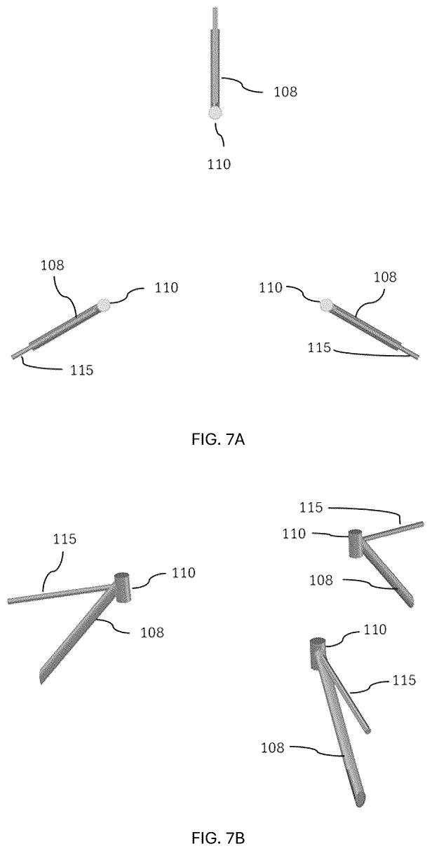

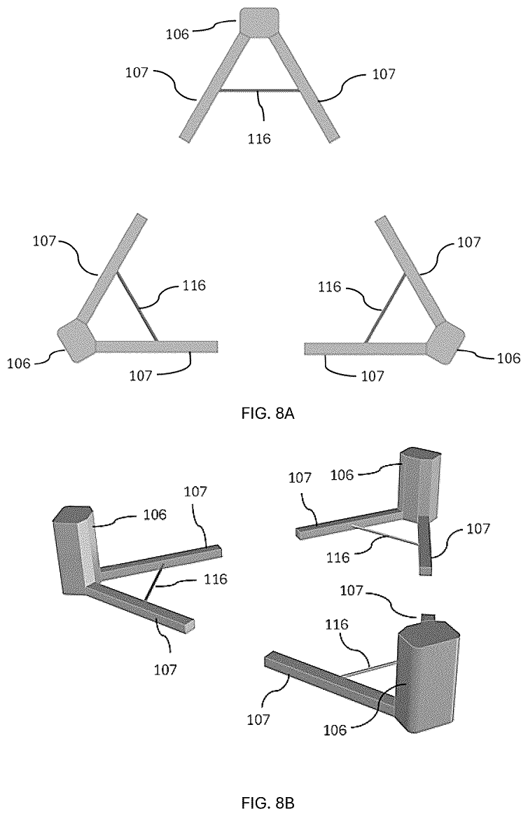

FIG. 5 illustrates the hull of this invention in its in-service condition, comprising the following structural components:
a) The modular transition assembly, detailed in FIGS. 6A and 6B.
b) Three modular supporting frame assemblies, detailed in FIGS. 7A and 7B.
c) Three modular column/pontoon assemblies, detailed in FIGS. 8A and 8B.
d) Three horizontal connection beams, detailed in FIG. 5.
e) Three horizontal connection trusses between columns of the modular column/pontoon assemblies and three horizontal connection trusses between the vertical trusses of the modular supporting frame assemblies are displayed in FIG. 5.

In FIG. 5, the lower end of the lower segment of tower 101 connects to the top of the column 102 via the modular transition assembly detailed in FIGS. 6A and 6B. The modular transition assembly consists of column 102, base 103, three horizontal connection beams 104, six horizontal supporting beams 112, three horizontal extension beams 113, and three slanted supporting beams 114. Column 102 connects to base 103 and is supported by three slanted supporting beams 114. Base 103 connects to three horizontal beams 104 and three horizontal extension beams 113. The three horizontal beams 104 are supported by six horizontal supporting beams 112 and three vertical supporting trusses 110 of the modular supporting frame assemblies. The three horizontal extension beams 113 support the three slanted supporting beams 114 and connect to the six horizontal supporting beams 112.

In FIG. 5, the modular transition assembly is supported by three vertical trusses 110, as detailed in FIGS. 7A and 7B. The modular supporting frame assembly consists of three slanted trusses 108, three vertical trusses 110, and three slanted connection trusses 115. Each top end of a slanted truss 108 connects to a vertical truss 110 at mid-height, while each low end connects to column 106 near the keel. The vertical truss 110 connects to the horizontal connection truss 111, the slanted truss 108, the slanted connection truss 115, connection beam 104, and connection beam 105. Each slanted connection truss 115 connects the slanted truss 108 at the inner end and column 106 at the outer end. The three supporting frame assemblies are interconnected by three connection trusses 111 near the center of the platform.

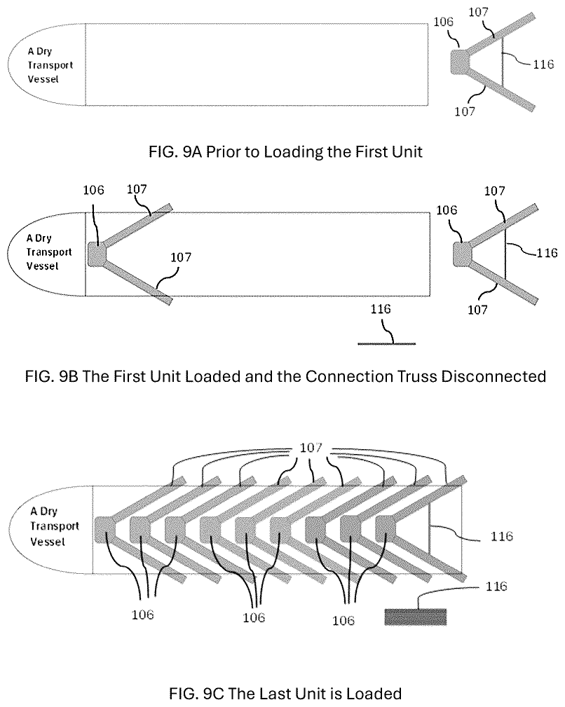

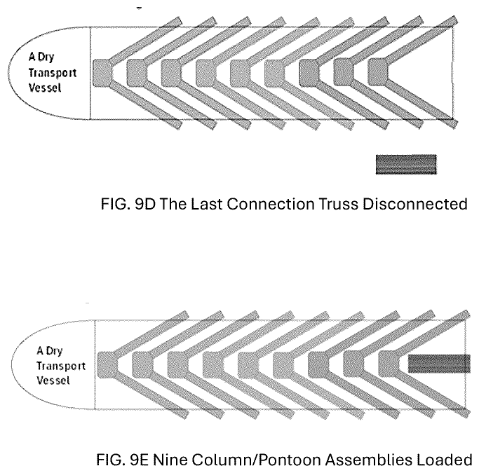

In FIG. 5, the modular supporting frame assembly connects to column 106 at the top through the slanted connection truss 115 and at the bottom through slanted truss 108. Column 106 is a structural component of the modular column/pontoon assembly detailed in FIGS. 8A and 8B. The modular column/pontoon assembly consists of one column 106, two half pontoon segments 107, and one connection truss 116. Column 106 connects to connection beams 105 and the slanted connection truss 115 at the top, and to one slanted truss 108 and two half pontoon segments 107 at the bottom. The three columns are tied together with three horizontal trusses 109 at the top and three pontoons 107 at the bottom. Each pontoon 107 consists of two half pontoon segments. One column 106 connects to half two pontoon segments, which are angled at 60 degrees and supported by connection truss 116. To facilitate dry transport, connection truss 116 is designed to be disconnectable and reconnectable. As illustrated in FIGS. 9A-9E, the connection truss 116 disconnects after the modular component of the column/pontoon assembly is loaded onto the DTV and reconnects prior to offloading the modular component.

This innovation facilitates the prefabrication and outsourcing of all modules to various yards, allowing for simultaneous construction at different locations. This approach shortens the overall schedule and enables the efficient transport of prefabricated modules to the foundation assembly yard, where they are integrated into the hull, as shown in FIG. 5. The modular components of the column/pontoon assemblies are identified as the most critical modules and are on the critical path of the prefabrication schedule. To demonstrate the efficiency and feasibility of the current innovation for dry transportation, a hull designed to support a 15 MW WTG is used as an example. The associated dimensions of the modular components of the column/pontoon assembly (FIGS. 8A and 8B) and a DTV with deck dimensions of 180 meters in length and 40 meters in breadth are considered. FIGS. 9A-9E illustrates the schematic procedure for uploading nine modular components of the column/pontoon assemblies onto the DTV.

In FIG. 9A, the DTV and one modular component of the column/pontoon assembly are depicted. In FIG. 9B, one modular component of the column/pontoon assembly is shown loaded onto the DTV, with connection truss 116 disconnected and temporarily placed at the designated location on land, while the second modular component of the column/pontoon assembly awaits. The procedures described earlier are repeated. In FIG. 9C, the ninth modular component of the column/pontoon assembly has been loaded onto the DTV. In FIG. 9D, the ninth connection truss 116 has been disconnected and positioned at the designated location on land. Finally, in FIG. 9E, all nine connection trusses 116 have been loaded onto the DTV.

The offloading procedure for the nine modular components of the column/pontoon assembly from the DTV is the reverse of the uploading procedure. The first step is to offload the nine connection trusses 116 to the designated location. The second step is to reconnect one connection truss 116 to two segments of pontoon 107 of the ninth modular component to assemble a complete ninth modular component with column 106, two segments of pontoon 107, and connection truss 116. Then, offload the complete modular component of the column/pontoon assembly from the DTV and place it at the designated location on land. Repeat the above offloading procedure until all nine modular components are offloaded from the DTV and placed at the designated locations on land.

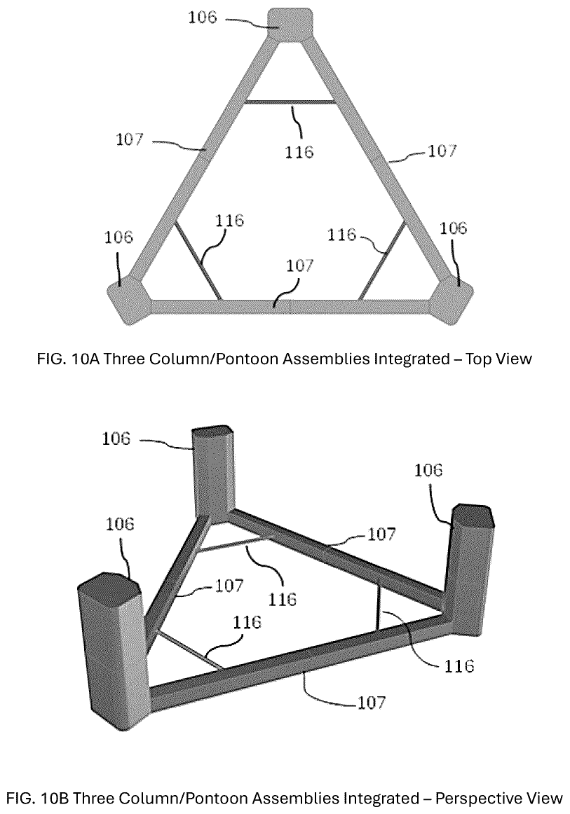

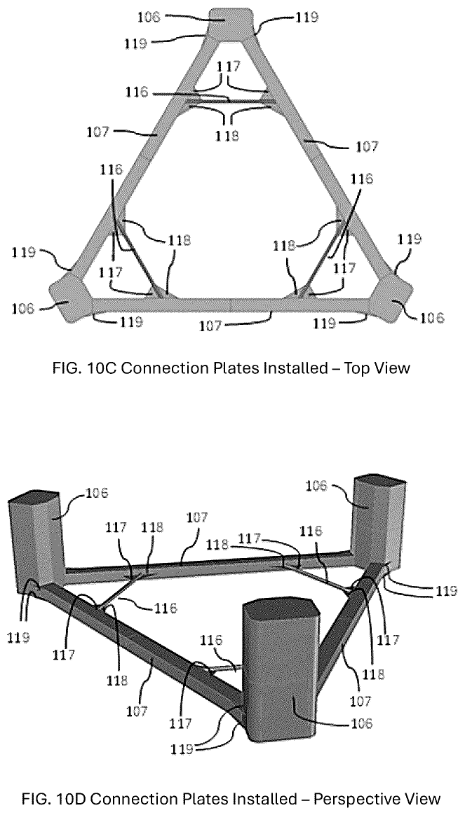

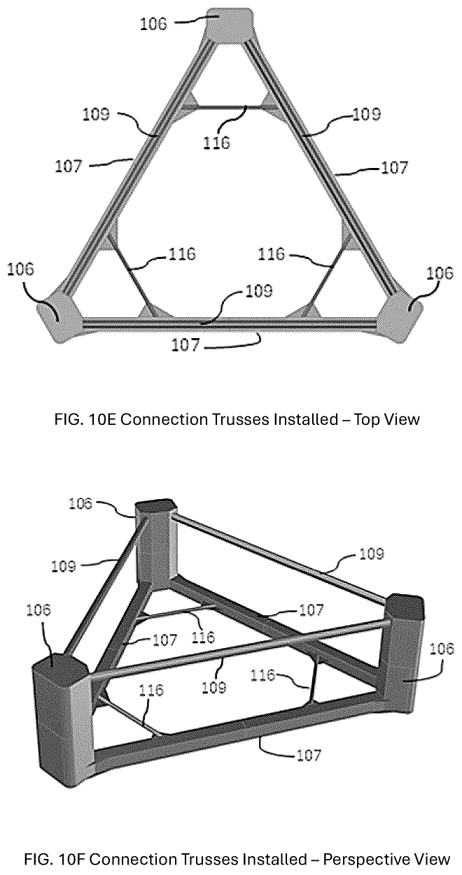

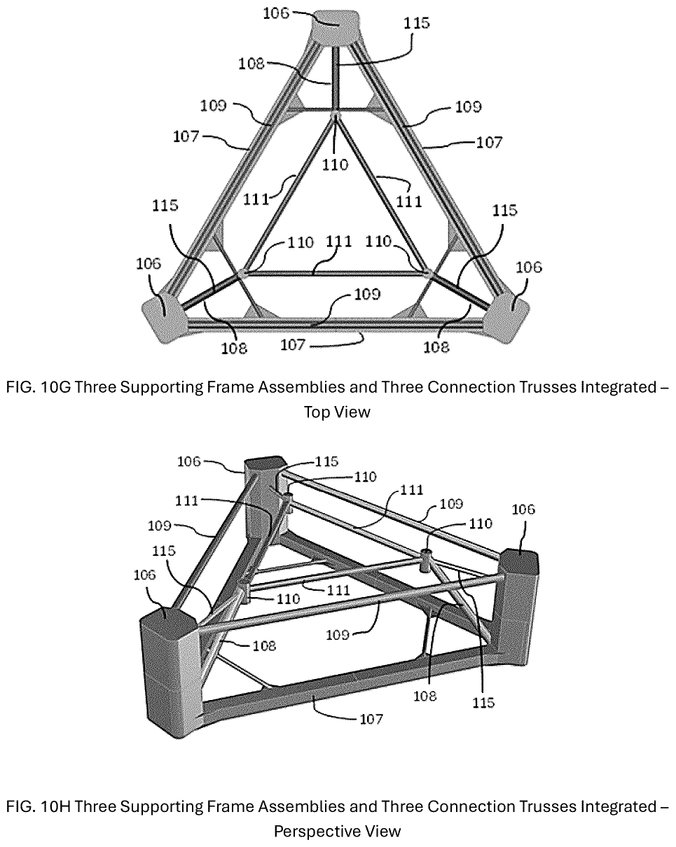

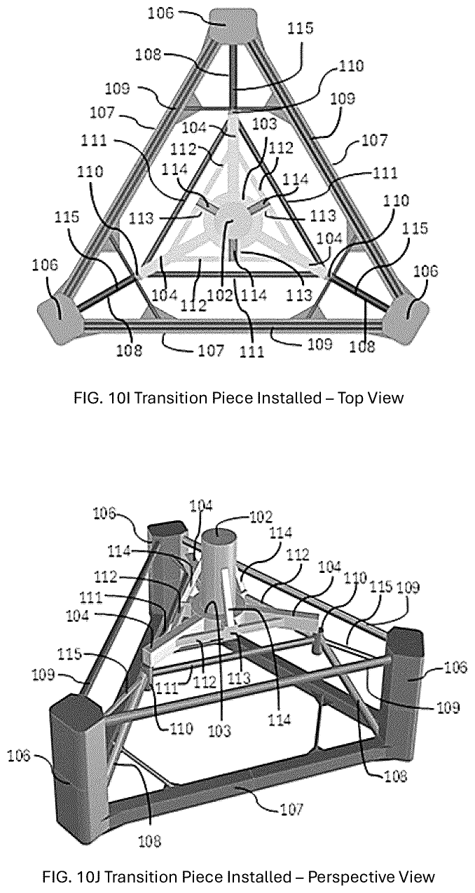

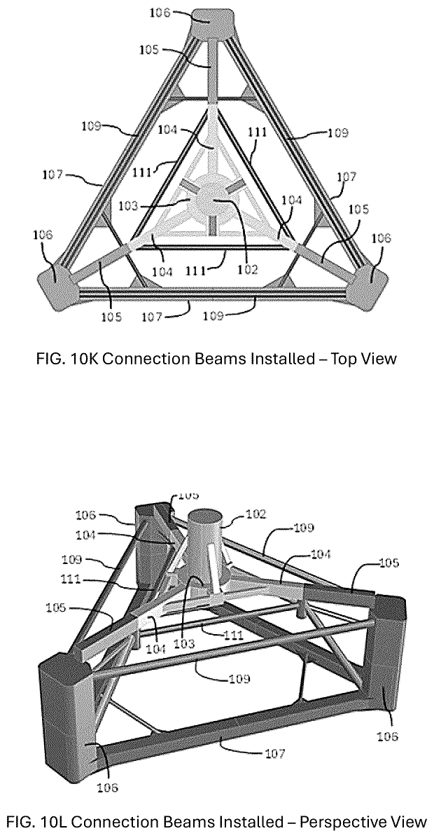

FIGS. 10A-10L illustrates the schematic procedure for assembling all structural components into a hull. Three modular components of the column/pontoon assembly are hooked up and displayed in FIGS. 10A and 10B. Both six connection plates 117 and six connection plates 118 between connection trusses and pontoons 107 are installed, as well as six connection plates between pontoons and columns at an elevation flat with the top of pontoon 107 and six connection plates between pontoons and columns at an elevation flat with the bottom of pontoon 107, as depicted in FIGS. 10C and 10D. Three horizontal trusses 109 and three columns 106 are tied together at the top of columns 106 and shown in FIGS. 10E and 10F. Three slanted connection trusses 115 and three slanted trusses 108 are connected to the corresponding columns 106 at the top and bottom, respectively; three horizontal connection trusses 111 are connected at the middle of the corresponding vertical trusses 110 and displayed in FIGS. 10G and 10H. The modular transition assembly is lifted, and three connection beams 104 are positioned and welded to the corresponding vertical trusses 110 at the top, as illustrated in FIGS. 10I and 10J. Three connection beams 105 are lifted and welded to the corresponding connection beams 104, vertical trusses 110, and columns 106, as shown in FIGS. 10K and 10L. Thus, the hull is assembled.

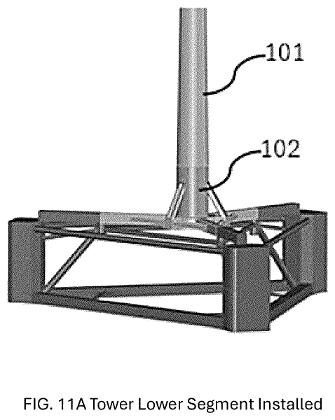

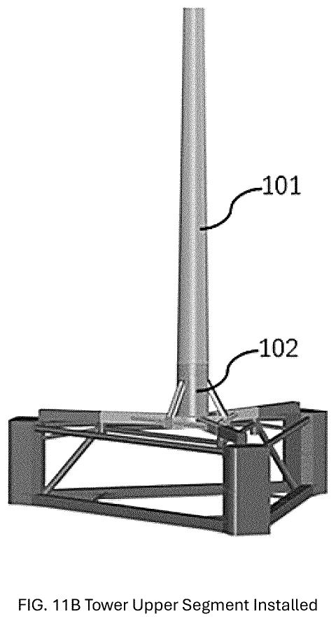

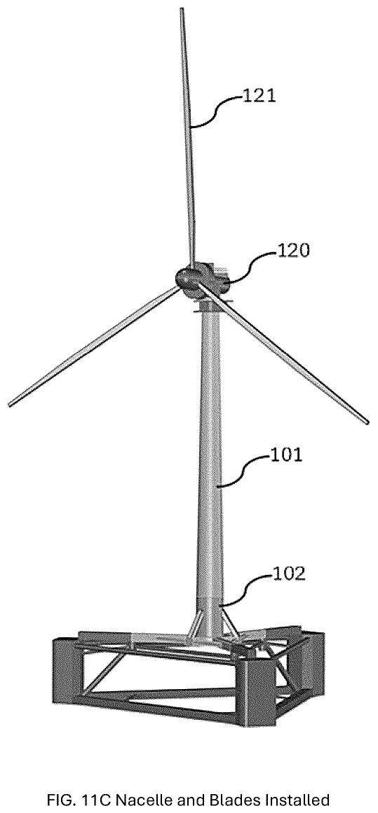

FIGS. 11A-11C display the schematic procedure for assembling all superstructure modules into a FOWT platform. The lower segment of tower 101 is lifted and installed on top of column 102 of the modular transition assembly, as shown in FIG. 11A. The upper segment of tower 101 is lifted and mounted on top of the lower segment of tower 101, as depicted in FIG. 11B. The nacelle 120 is lifted and installed on top of upper segment of tower 101, and then three blades 121 are lifted and connected to the nacelle 120, as shown in FIG. 11C. Thus, the FOWT platform is assembled.

1. A floating structure foundation comprising:
three modular components of the column/pontoon assemblies; and
three connection trusses coupled to the column/pontoon assembles, each of the connection trusses being oriented horizontally; and
three modular components of the supporting frame assemblies coupled to the three column/pontoon assembles; and
three connection trusses coupled to the supporting frame assemblies, each of the connection trusses being oriented horizontally; and
one modular transition assembly coupled to the supporting frame assemblies; and
three connection beams coupled to the column/pontoon assemblies, the transition assembly, and the supporting frame assemblies.

2. The floating structure foundation of claim 1, wherein the three column/pontoon assemblies comprise three columns oriented vertically, six half pontoons, and three connection trusses, with both the half pontoons and connection trusses oriented horizontally. Each column/pontoon assembly modular comprises one column, two half pontoons, and one connection truss. The angle between the two half pontoons is 60 degrees, and the connection truss is coupled to the two half pontoons. Two half pontoons from two adjacent modulars are coupled to form one pontoon, which is then coupled between two of the three columns to form a triangular shape. Part of the columns is above the water line to provide stability, while the remaining part of the columns and the entire pontoons are submerged. The buoyancy of the floating structure foundation primarily comes from the three submerged columns and pontoons.

3. The floating structure foundation of claim 1, wherein each of the three horizontally oriented connection trusses is coupled to the tops of two of the three columns of the column/pontoon assemblies to form a triangular shape.

4. The floating structure of claim 1, wherein the three supporting frame assemblies comprise three slanted trusses, three vertical trusses, and three slanted connection trusses. Each modular supporting frame assembly comprises one slanted truss, one vertical truss, and one slanted connection truss, with the upper end of the slanted truss coupled to the middle of the vertical truss and the inner end of the slanted connection truss coupled to the upper end of the slanted truss to form a triangular shape. Each modular supporting frame assembly is coupled to the inner side of the corresponding column at the top through the outward end of the slanted connection truss and at the bottom through the lower end of the slanted truss. The angle between the slanted truss and the corresponding column is configured to provide optimal support for load transfer.

5. The floating structure foundation of claim 1, wherein each of the three horizontally oriented connection trusses is coupled to the middle of two of the three vertical trusses of the corresponding supporting frame assemblies to form a triangular shape.

6. The floating structure foundation of claim 1, wherein the modular transition assembly comprises one column, one base, three connection beams, three extension beams, six supporting beams, and three slanted supporting beams. All connection beams, extension beams, and supporting beams are oriented horizontally. The column is coupled to the base, and the three connection beams and three extension beams are also coupled to the base. The angles between each pair of connection beams and extension beams are 120 degrees, while the angle between each connection beam and extension beam is 60 degrees. Each of the six supporting beams is coupled between the corresponding connection beam and extension beam. Each of the three slanted beams is coupled to the top of the column and to the extension beams to form a triangular shape. To achieve optimal load resistance to forces and moments at the base, the height of the column, the length of the extension beams, and the angle of the slanted supporting beams can be adjusted.

7. The floating structure foundation of claim 1, wherein the modular transition assembly is located at the center of the structure, and its connection beams are coupled to the tops of the corresponding vertical trusses of the supporting frame assemblies.

8. The floating structure foundation of claim 1, wherein one outward end of each of the three horizontally oriented connection beams is coupled to the top of the corresponding column of the column/pontoon assemblies. The inner end of each connection beam is coupled to the outward end of the corresponding connection beam of the modular transition assembly and to the top of the corresponding vertical truss of the supporting frame assemblies. Thus, the modular transition assembly, the three supporting frame assemblies, and the three column/pontoon assemblies are interconnected through the three connection beams.

9. The floating structure foundation of claim 2, wherein the three connection trusses of the column/pontoon assemblies are designed to be disconnectable and reconnectable. During the dry transportation of the modular components of the column/pontoon assemblies, the connection trusses can be disconnected and removed to allow more modular components to be loaded onto a DTV and then reconnected prior to offloading the modular components.

10. The floating structure foundation of claim 2, wherein the shape of the column of the column/pontoon assembly may be a six-sided polygonal shape, cylindrical, or any other form, and the column can be constructed from metal, concrete, or composites. Similarly, the shape of the pontoon of the column/pontoon assemblies may be rectangular, square, round, or any other shape, and the pontoon can also be made from metal, concrete, or composites.

11. The floating structure foundation of claim 4, wherein the shape of the slanted truss of the supporting frame assembly may be cylindrical, rectangular, square, or any other form, and the slanted truss can be constructed from metal, concrete, or composites. Similarly, the shape of the vertical truss of the supporting frame assembly may be cylindrical, six-sided polygonal, or any other shape, and the vertical truss can also be made from metal, concrete, or composites.

12. The floating structure foundation of claim 6, wherein the shape of the column and base of the modular transition assembly may be cylindrical, rectangular, square, or any other form, and the column and base can be constructed from metal, concrete, or composites. Similarly, the shape of the connection beams, extension beams, supporting beams, and slanted supporting beams of the modular transition assembly may be rectangular, square, cylindrical, or any other shape, and these beams can also be made from metal, concrete, or composites.

13. A method of uploading and offloading modular components of the column/pontoon assemblies onto a DTV comprising:
a) Uploading the first modular component of the column/pontoon assembly onto the DTV;
b) Disconnecting the connection truss between two half pontoons and placing it at the designated location on land;
c) Securing the first modular component on the DTV deck and then uploading the second modular component of the column/pontoon assembly onto the DTV next to the first modular component, ensuring proper spacing between the two modular components;
d) Repeating step b until all modular components of the column/pontoon assemblies have been uploaded;
e) Uploading all connection trusses onto the DTV deck and sailing away;
f) Offloading all connection trusses from the DTV and reconnecting the connection truss to the two half pontoons of the last modular component of the column/pontoon assembly on the DTV deck;
g) Offloading the re-assembled modular component of the column/pontoon assembly from the DTV deck and placing it at the designated location;
h) Repeating step g until all modular components of the column/pontoon assemblies have been re-assembled and offloaded from the DTV deck and placed at their designated locations.

14. A method of integrating and assembling all structural components presented in claim 1 into a floating structure foundation comprising:
i). Coupling three modular components of the column/pontoon assemblies at the ends of two half pontoons of two of the three modular components to form a triangular shape at the bottom;
ii). Coupling each of the three connection trusses at the tops of two of the three corresponding columns to form a triangular shape at the top;
iii). Coupling twelve connection plates with the corresponding pontoons and connection trusses at their mid-depth;
iv). Coupling six connection plates with the corresponding column and pontoon at the elevation flatly of the top of the pontoon, and six connection platforms with the corresponding column and pontoon at the elevation flatly of the bottom of the column and pontoon;
v). Coupling each of the three supporting frame assemblies to the corresponding column inner sides at the tops through the slanted connection trusses and at the bottoms through the slanted trusses;
vi). Coupling each of the three connection trusses at the mid-depths of two of the three corresponding vertical trusses of the supporting frame assemblies to form a triangular shape;
vii). Coupling each of the three connection beams of the modular transition assembly to the top of each of the three vertical trusses of the three supporting frame assemblies;
viii). Coupling each of the three connection beams at the top of the corresponding column of the column/pontoon assembly, at the top of the corresponding vertical truss of the supporting frame assembly, and at the outward end of the corresponding connection beams of the transition assembly. Thus, the modular transition assembly, the three supporting frame assemblies, and the three column/pontoon assemblies are interconnected through the three connection beams.

15. A floating offshore wind turbine platform comprising: a floating structure foundation; and
a tower oriented vertically coupled to the floating structure foundation; and
a nacelle coupled to the top of the tower; and
blades coupled to the nacelle.

16. The floating offshore wind turbine platform of claim 15, wherein the lower end of the lower segment of the tower is coupled to the top of the column of the modular transition assembly of the floating structure foundation.

17. A method of integrating and assembling all components presented in claim 15 into a floating offshore wind turbine platform comprising:
1). The lower segment of the tower is coupled to the top of the column of the modular transition assembly at the center of the structure foundation at the quayside;
2). The upper segment of the tower is coupled to the top of the lower segment of the tower at the quayside;
3). The nacelle is coupled to the top of the upper segment of the tower at the quayside;
4). The blades are coupled to the nacelle at the quayside.
